(19) United States
(12) Patent Application Publication
(10) Pub. No.: US 2016/0337308 A1
(43) Pub. Date: Nov. 17, 2016

(54) ELECTRONIC MAIL PROMPTING METHOD AND SERVER

(71) Applicant: Alibaba Group Holding Limited, Grand Cayman (KY)

(72) Inventors: Guangqian Dong, Hangzhou (CN); Hang Chen, Hangzhou (CN)

(21) Appl. No.: 15/152,446

(22) Filed: May 11, 2016

(30) Foreign Application Priority Data
May 14, 2015 (CN) 201510245852.1

(51) Int. Cl. H04L 12/58; G06F 17/30

(52) U.S. Cl. CPC H04L 51/36; H04L 51/04; H04L 51/24; G06F 17/30604; G06F 17/3053

(57) ABSTRACT

An electronic mail prompting method is disclosed. The method includes receiving an electronic mail, and obtaining a first identity identifier that identifies a mail sender and a second identity identifier that identifies a mail recipient based on the electronic mail; obtaining relationship data between the first identity identifier and the second identity identifier; and sending a prompting command to an instant communication server based on the relationship data and in accordance with a predetermined rule, the prompting command including the second identity identifier. The electronic mail prompting method can effectively improve the timeliness of informing a user of an electronic mail.

### CROSS REFERENCE TO RELATED PATENT APPLICATION

This application claims foreign priority to Chinese Patent Application No. 201510245852.1 filed on May 14, 2015, entitled “Electronic Mail Prompting Method and Server”, which is hereby incorporated by reference in its entirety.

### TECHNICAL FIELD

The present disclosure relates to the field of network communications, and more particularly, to electronic mail prompting methods and servers.

### BACKGROUND

With the popularity of computers, employees from the same company or from different companies more often use electronic mails to communicate with one another in daily work. This type of communication mode has relatively high confidentiality and stability. Specifically, for example, personal email boxes are configured with logins by means of accounts and passwords, and electronic mails cannot be read unless a respective email box is logged in. Electronic mails are mainly stored in a server terminal. Therefore, an entire electronic mail sending and receiving system is relatively stable, and a loss of electronic mails does not often occur.

As the development of companies increasingly rely on electronic mails, the requirement on timeliness of informing an employee of an electronic mail becomes increasingly high. In most existing electronic mail systems, a user cannot know whether a new electronic mail is received before logging in to the email box via a computer. If the user is very busy for a period of time and does not have time to turn on the computer to check electronic mails, a long time may have elapsed before the user can read important information.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

An objective of the embodiments of the present disclosure is to provide a method and a server for prompting an electronic mail that can effectively improve the timeliness of informing a user of the electronic mail.

To solve the above technical problem, the present disclosure provides an electronic mail prompting method, which may include receiving an electronic mail and obtaining a first identity identifier that identifies a mail sender and a second identity identifier that identifies a mail recipient according to the electronic mail; obtaining relationship data between the first identity identifier and the second identity identifier; and sending a prompting command to an instant communication server based on the relationship data in accordance with a predetermined rule, the prompting command including the second identity identifier.

The present disclosure further provides a server, which may include a mail receiving module used for receiving an electronic mail and obtaining a first identity identifier that identifies a mail sender and a second identity identifier that identifies a mail recipient according to the electronic mail; an acquisition module used for obtaining relationship data between the first identity identifier and the second identity identifier; and a prompting command sending module used for sending a prompting command to an instant communication server based on the relationship data in accordance with a predetermined rule, the prompting command including the second identity identifier.

The present disclosure further provides an electronic mail prompting method, which may include: receiving a prompting command sent by a mail server, the prompting command including an identity identifier; and sending prompting information to a client terminal corresponding to the identity identifier.

The present disclosure further provides an electronic mail prompting method, which may include receiving mail sending information and obtaining a first identity identifier that identifies a mail sender and a second identity identifier that identifies a mail recipient according to the mail sending information; obtaining relationship data between the first identity identifier and the second identity identifier; and sending prompting information to a client terminal corresponding to the second identity identifier based on the relationship data in accordance with a predetermined rule.

The present disclosure further provides a server, which may include an information receiving module used for receiving mail sending information and obtaining a first identity identifier that identifies a mail sender and a second identity identifier that identifies a mail recipient according to the mail sending information; an acquisition module used for obtaining relationship data between the first identity identifier and the second identity identifier; and a prompting information sending module used for sending prompting information to a client terminal corresponding to the second identity identifier based on the relationship data in accordance with a predetermined rule.

The present disclosure further provides an electronic mail prompting method, which may include receiving an electronic mail and obtaining a first identity identifier that identifies a mail sender and a second identity identifier that identifies a mail recipient according to the electronic mail; obtaining relationship data between the first identity identifier and the second identity identifier; and sending prompting information to a client terminal corresponding to the second identity identifier based on the relationship data in accordance with a predetermined rule.

As can be seen from the above technical solutions provided in the embodiments of the present disclosure, by combining an electronic mail system with an instant communication technology, and further using a social relationship between a mail sender and a mail recipient (i.e., representing the social relationship via relationship data), the present disclosure is able to distinguish an importance level of a current mail with respect to the mail recipient based on the social relationship between the mail sender and the mail recipient. In this way, sending prompting information to an instant communication client terminal of a user based on relationship data can be achieved, thus enabling the user to learn that a new mail is to be read as soon as possible, and thereby effectively improving the timeliness of a response of the user with respect to the mail, especially the timeliness of responding to important mails by the user.

### BRIEF DESCRIPTION OF THE DRAWINGS

In order to describe the technical solutions in the embodiments of the present disclosure or existing technologies in a clearer manner, drawings used in the description of the embodiments or the existing technologies are briefly introduced herein. Apparently, the described drawings merely represent some embodiments of the present disclosure. One of ordinary skill in the art may also obtain other drawings according to these drawings without making any creative effort.

FIG. 1 is a flowchart of an electronic mail prompting method according to an embodiment of the present disclosure.

FIG. 2 is a flowchart of an electronic mail prompting method according to an embodiment of the present disclosure.

FIG. 3 is a flowchart of an electronic mail prompting method according to an embodiment of the present disclosure.

FIG. 4 is a block diagram of a server according to an embodiment of the present disclosure.

FIG. 5 is a flowchart of an electronic mail prompting method according to an embodiment of the present disclosure.

FIG. 6 is a flowchart of an electronic mail prompting method according to an embodiment of the present disclosure.

FIG. 7 is a flowchart of an electronic mail prompting method according to an embodiment of the present disclosure.

FIG. 8 is a flowchart of an electronic mail prompting method according to an embodiment of the present disclosure.

FIG. 9 is a block diagram of a server according to an embodiment of the present disclosure.

FIG. 10 is a flowchart of an electronic mail prompting method according to an embodiment of the present disclosure.

### DETAILED DESCRIPTION

In order to facilitate one skilled in the art to understand the technical solutions of the present disclosure in a better manner, the technical solutions in the embodiments of the present disclosure will be clearly and comprehensively described hereinafter with reference to the accompanying drawings in the embodiments of the present disclosure. Apparently, the described embodiments represent merely a portion and not all of the embodiments of the present disclosure. All other embodiments that are obtained by one of ordinary skill in the art based on the embodiments of the present disclosure without making any creative effort shall fall within the scope of protection of the present disclosure.

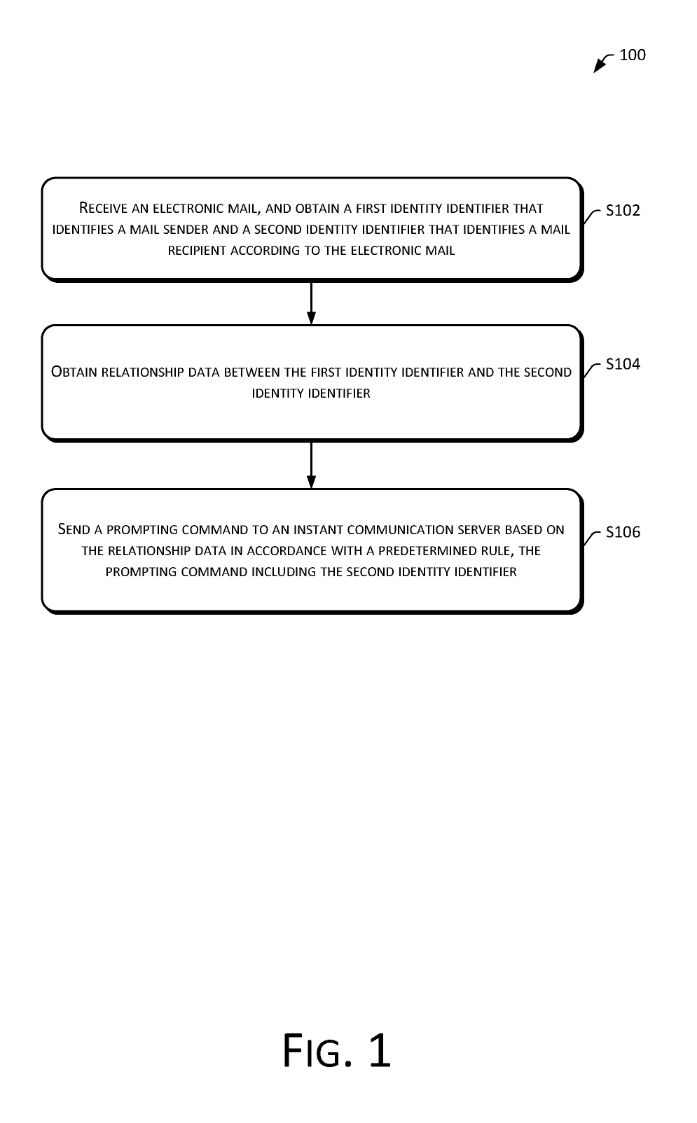

FIG. 1 illustrates an electronic mail prompting method 100 that is provided according to an embodiment of the present disclosure, which may include the following method blocks.

S102 receives an electronic mail, and obtains a first identity identifier that identifies a mail sender and a second identity identifier that identifies a mail recipient according to the electronic mail.

In implementations, a mail sender may be a user that sends an electronic mail. A mail recipient may be a user that receives an electronic mail. An identity identifier can be used to uniquely identify a user, and the user may be a mail sender or may be a mail recipient. By way of example and not limitation, an identity identifier may be a character string that is defined according to a predetermined rule, for example, an email box account, or a name that is self-defined by a user.

In implementations, an approach of obtaining the first identity identifier and the second identity identifier based on the electronic mail sent by the mail sender may include reading the first identity identifier and the second identity identifier from the electronic mail after the electronic mail is received. In implementations, the first identity identifier and the second identity identifier may be email box addresses of respective users. Alternatively, an approach of obtaining the first identity identifier and the second identity identifier may include obtaining an email box account of the mail sender and an email box account of the mail recipient after the electronic mail is received, and finding the first identity identifier bound to the email box account of the mail sender and the second identity identifier bound to the email box account of the mail recipient from a stored database according to the email box addresses.

S104 obtains relationship data between the first identity identifier and the second identity identifier.

In implementations, relationship data may be used to represent a social relationship between users identified by identity identifiers. In implementations, relationship data may include a social relationship such as a hierarchical relationship in a company, a family relationship, a business relationship, or a friend relationship, etc. The hierarchical relationship may include superior, subordinate, peer, etc. The business relationship may include, for example, an ordinary customer, an important customer, a supplier, etc. The family relationship may include a father, a mother, an elder brother, a younger brother, a wife, a son, a daughter, etc. Apparently, the relationship data is not limited to the above examples, and one skilled in the art may also make other modifications under the insights of the technical essences of the present disclosure. Such modifications shall all fall within the scope of protection of the present disclosure, given that functions and effects that are the same as or similar to those of the present disclosure are achieved. In implementations, a form of representation of the relationship data may be a character string, which is used to represent a social relationship.

In implementations, a method of correspondingly storing the first identity identifier, the second identity identifier and the relationship data may be performed in terms of a data table. In the data table, a first column of data records identity identifiers from a first person, a second column of data records identity identifiers of target persons, and a third column of data is used to represent respective relationship data. A row of data in the data table may form a data object, and the data object includes an identity identifier from a first person, an identity identifier of a target person, and relationship data correspondingly. The relationship data may be used to represent a relationship between users that are identified by the identity identifier from the first person and the identity identifier of the target person. For example, a data object may include an identity identifier from a first person which is used to identify a user A, an identity identifier of a target person which is used to identify a user B, and relationship data being a superior. In this case, the user B can be considered as a superior of the user A. For another example, an identity identifier from a first person represents a user B, an identity identifier of a target person represents a user A, and relationship data is subordinate. In this case, the user A can be understood as a subordinate of the user B. Therefore, both the first identity identifier and the second identity identifier can be used as an identity identifier of a first person or an identity identifier of a target person. A difference is that respective relationship data may be different when the first identity identifier and the second identity identifier are individually used as an identity identifier a first person. Apparently, other data structures may also be used to store identity identifiers and relationship data in a corresponding manner. For example, a user may be considered as a data object, with an identity identifier and relationship data being treated as attributes of this data object. Apparently, one skilled in the art may also make other modifications, which shall fall within the scope of protection of the present disclosure, given that same or similar functions and effects as those in the present disclosure are achieved.

In implementations, a method of obtaining the relationship data may include searching for the relationship data that corresponds to the first identity identifier and the second identity identifier from locally stored relationship data, or may include downloading the relationship data from a predetermined server. In implementations, the second identity identifier that identifies the mail recipient may be searched from a data column that records identity identifiers of first persons during search to find the relationship data having the mail recipient as the first person.

S106 sends a prompting command to an instant communication server based on the relationship data in accordance with a predetermined rule, the prompting command including the second identity identifier.

In implementations, the instant communication server may provide a platform for instant communications between client terminals. Specifically, when different client terminals exchange instant communication information, information may be sent to the instant communication server first. In response to receiving the instant communication information, the instant communication server sends the information to a target client terminal. Specifically, the instant communication server may be a telecommunication device having computation, storage and network communication functions, or may be software that runs in the telecommunication device.

In implementations, the predetermined rule may include a rule that is set in advance, and the prompting command is sent when the relationship data satisfies logical settings of the rule. For example, the predetermined rule may include sending the prompting command when the mail sender is a superior or a senior family member of the mail recipient. Additionally, levels may be set up for roles represented by each piece of relationship data may be ranked. For example, in a company, a senior leader has a level of 3, an immediate superior has a level of 2, and a peer has a level of 1. For another example, father and mother have a level of 3, wife and son have a level of 2, and other relatives have a level of 1 or 0. The predetermined rule may further include sending the prompting command when the mail sender has a level higher than 2.

In implementations, sending the prompting command to the instant communication server may represent that the instant communication server is needed to send prompting information to a client terminal to inform a user identified by the second identity identifier that a mail is to be read. The instant communication server may send the prompting information to an instant communication client terminal used by the user that is identified by the second identity identifier according to the second identity identifier. Specifically, the prompting command may be a character string that is configured according to the predetermined rule. The second identity identifier included in the prompting command may be included as a portion of content of the prompting command, or may be included as an attachment to the prompting command.

In implementations of the present disclosure, by combining an electronic mail system with an instant communication technology, and further using a social relationship between a mail sender and a mail recipient (i.e., representing the social relationship via relationship data), an importance level of a current mail with respect to the mail recipient can be recognized based on the social relationship between the mail sender and the mail recipient. In this way, sending prompting information to an instant communication client terminal of a user based on relationship data can be achieved, thus enabling the user to learn that a new mail is to be read as soon as possible, and thereby effectively improving the timeliness of a response of the user with respect to the mail, especially the timeliness of responding to important mails by the user.

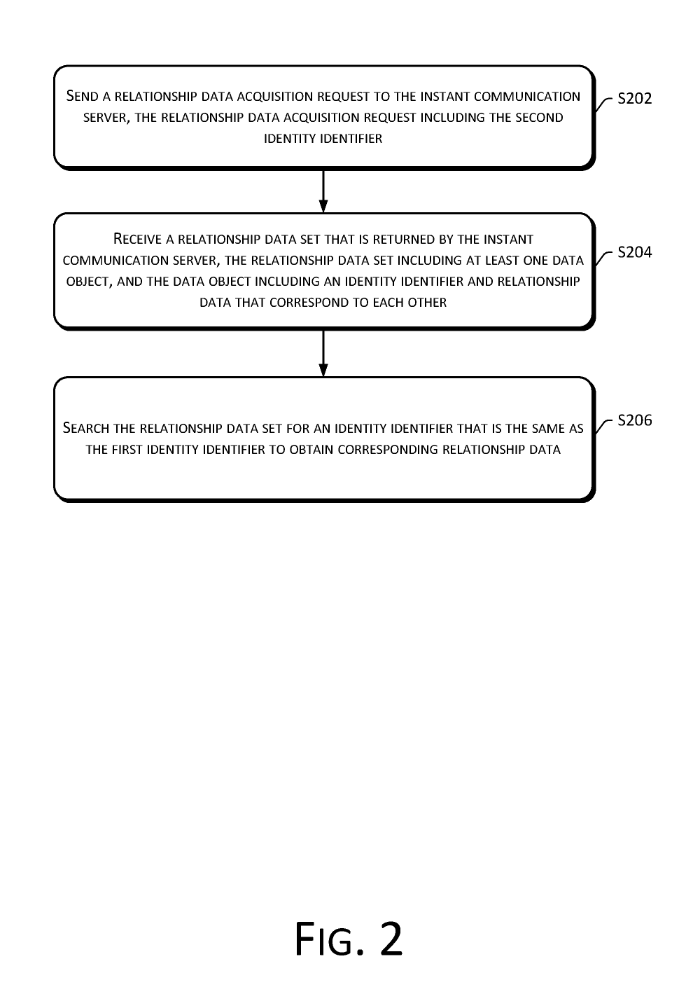

Referring to FIG. 2, in implementations, the method block S104 may include the following sub-blocks:

S202 sends a relationship data acquisition request to the instant communication server, the relationship data acquisition request including the second identity identifier.

In implementations, the relationship data may be stored in the instant communication server. In response to receiving the mail, a relationship data acquisition request may be sent to the instant communication server to obtain the relationship data.

In implementations, the relationship data acquisition request includes the second identity identifier to obtain the relationship data corresponding to the second identity identifier. The second identity identifier is used to identify the user of the mail recipient, so that the obtained relationship data corresponds to relationship data that is created with the mail recipient as the first person.

In implementations, the second identity identifier included in the relationship data acquisition request may be included as a portion of content of the relationship data acquisition request, or may be included as an attachment to the relationship data acquisition request. For example, if the second identity identifier is “123@taobao.com”, the content of the relationship data acquisition request may be “request 123@taobao.com”. Alternatively, the content of the relationship data acquisition request may be “request”, with “123@taobao.com” as an attachment.

S204 receives a relationship data set that is returned by the instant communication server, the relationship data set including at least one data object, and the data object including an identity identifier and relationship data that correspond to each other.

In implementations, after receiving the relationship data acquisition request, the instant communication server searches locally stored data for relationship data that corresponds to the second identity identifier, and forms a relationship data set using a search result that is found. Specifically, the instant communication server searches a data column that records identity identifiers of first persons in a locally stored data table for an identity identifier that is the same as the second identity identifier, and uses a search result thereof together with an identity identifier of a corresponding target person and relationship data to form a relationship data set. The data object may include an identity identifier of a first person, an identity identifier of a target person and relationship data. It may also be understood as forming a data object from data recorded in a row of the data table.

S206 searches the relationship data set for an identity identifier that is the same as the first identity identifier to obtain corresponding relationship data.

In implementations, the relationship data set returned by the instant communication server may be understood as all corresponding data objects with the second identity identifier serving as an identity identifier of a first person. In this way, if the first identity identifier is found in the relationship data set, a data object including the first identity identifier can be determined, and relationship data in the data object can be obtained.

In implementations, by universally storing relationship data in the instant communication server, a mail server does not need to store and manage the relationship data, thus avoiding redundant data storage and thereby conserving a storage space and reducing data management costs.

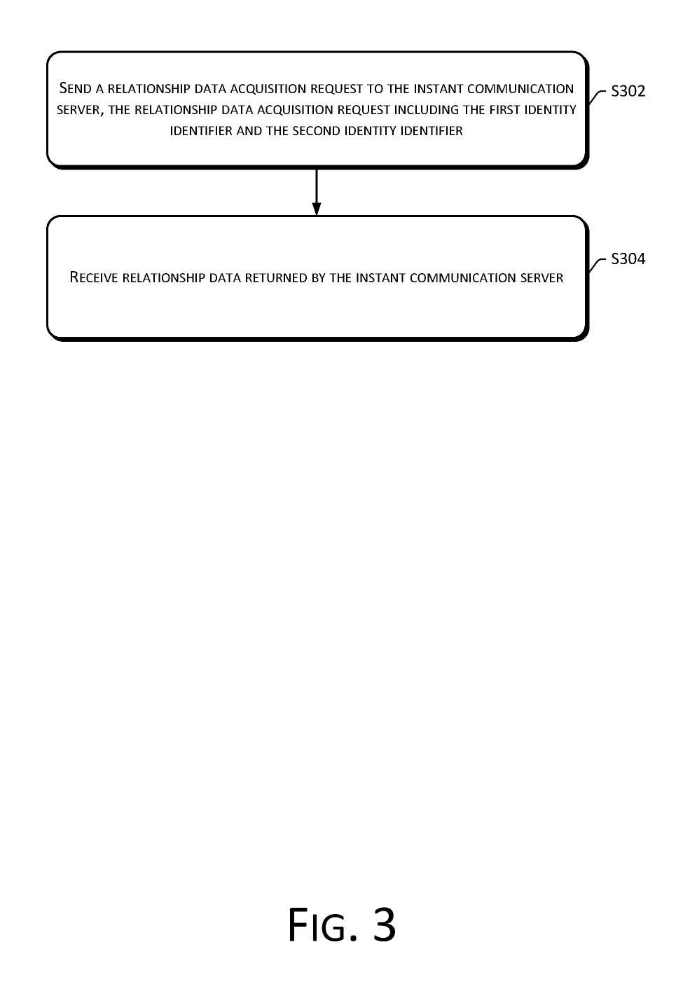

Referring to FIG. 3, in implementations, the method block S104 may include the following blocks.

S302 sends a relationship data acquisition request to the instant communication server, the relationship data acquisition request including the first identity identifier and the second identity identifier.

S304 receives relationship data returned by the instant communication server.

In implementations, the instant communication server stores relationship data, and a relationship data acquisition request is sent to the instant communication server to obtain relationship data that is needed. The relationship data acquisition request includes the first identity identifier and the second identity identifier, to facilitate the instant communication server to accurately find the relationship data. For example, after receiving the relationship data acquisition request, the instant communication server searches a stored data table for data objects in which the second identity identifier serves as an identity identifier of a first person, and further searches the data objects for a data object in which the first identity identifier serves as an identity identifier of a target person to obtain corresponding relationship data.

In implementations, the method block S104 may include reading locally stored relationship data that corresponds to the first identity identifier and the second identity identifier.

In implementations, since relationship data is locally stored, corresponding relationship data can be obtained by locally searching for the first identity identifier and the second identity identifier. Specifically, searching for a data object in which the second identity identifier serves as an identity identifier of a first person and the first identity identifier serves as an identity identifier of a target person is performed to obtain relationship data in the data object.

In implementations, the predetermined rule in the method block S106 may include sending the prompting command when the relationship data is predetermined relationship data.

In implementations, a plurality of pieces of predetermined relationship data may be set in advance, and the prompting command is sent only when obtained relationship data corresponds to a piece of predetermined relationship data. The predetermined relationship data may include specific relationship data that is designated. For example, the predetermined relationship data may include senior leader, immediate superior and the like.

In implementations, the relationship data may be used to represent a social relationship or a family relationship, and the predetermined relationship data may represent a superior leader or a senior family member. Therefore, it may be treated that a mail sent from a superior leader or a senior family member is relatively important, and a user needs to be reminded to read the mail timely. For example, superior leaders may include a senior leader and an immediate superior. Senior family members may include grandfather, grandmother, father, mother, uncle and the like.

In implementations, levels may be assigned to relationship data according to respective social relationships or family relationship represented by the relationship data, and the predetermined rule may include sending the prompting command when obtained relationship data having a level higher than a predetermined level.

In implementations, a role represented by the relationship data may be ranked. For example, in a company, a senior leader has a ranking of 3, an immediate superior has a ranking of 2, and a peer has a ranking of 1. For another example, father and mother have a ranking of 3, wife and son have a ranking of 2, and other relatives have a ranking of 1 or 0. The obtained relationship data also has a corresponding ranking. By setting a predetermined ranking in advance, relationship data for which a prompting command needs to be sent and relationship data for which no prompting command needs to be sent can be distinguished. In addition, when a user configures whether a prompting command needs to be sent, a modification process can be completed simply by modifying a ranking of a piece of relationship data or modifying a predetermined ranking, thus facilitating the user to perform configuration.

In implementations, the relationship data is used to represent an importance level, and the predetermined rule may include sending the prompting command when the relationship data having an important level larger than or equal to a predetermined importance level.

In implementations, the relationship data is used to represent an importance level. The importance level can be used to represent a relationship between the user corresponding to the first identity identifier and the user corresponding to the second identity identifier. Similarly, the importance level corresponds to the mail recipient as a first person. The higher the importance level is, the more important the mail sender is to the mail recipient, and therefore the mail recipient needs to process the mail in time. For example, a user A, a user B and a user C exist, where the user C is an ordinary employee, the user A is a senior leader, and the user B is an immediate superior of the user C. With the user C as the first person, the user A may have an importance level of 3, the user B may have an importance level of 2, and the predetermined importance level may be 2. In this case, when the user A or the user B sends a mail to the user C, a prompting command will be sent to the instant communication server, to cause the instant communication server to notify a client terminal of the user C that an electronic mail is to be read. With the user B as a first person, the user A may have an importance level of 3, the user C may have an importance level of 1, and the predetermined importance level may be 2. In this case, when the user A sends an electronic mail to the user B, a client terminal of the user B will receive prompting information. On the other hand, when the user C sends an electronic mail to the user B, the client terminal of the user B will not receive prompting information.

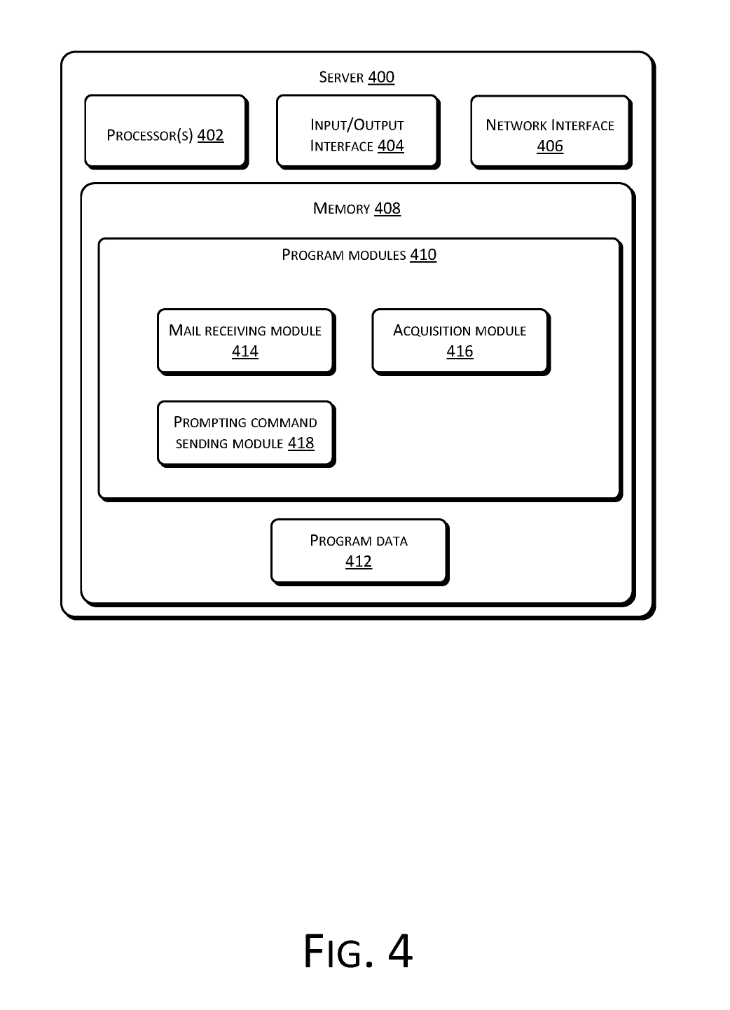

Referring to FIG. 4, the embodiments of the present disclosure further provide a server 400. In implementations, the server 400 may include one or more computing devices. By way of example and not limitation, the server 400 may include one or more processors 402, an input/output (I/O) interface 404, a network interface 406 and memory 408.

The memory 408 may include a form of computer-readable media, e.g., a non-permanent storage device, random-access memory (RAM) and/or a nonvolatile internal storage, such as read-only memory (ROM) or flash RAM. The memory 408 is an example of computer-readable media.

The computer-readable media may include a permanent or non-permanent type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer-readable media does not include transitory media, such as modulated data signals and carrier waves.

In implementations, the memory 408 may include program modules 410 and program data 412. The program modules 410 may include a mail receiving module 414, an acquisition module 416, and a prompting command sending module 418.

The mail receiving module 414 may receive an electronic mail, and obtain a first identity identifier that identifies a mail sender and a second identity identifier that identifies a mail recipient based on the electronic mail.

In implementations, a mail sender may be a user that sends an electronic mail. A mail recipient may be a user that receives an electronic mail. An identity identifier can be used to uniquely identify a user, and the user may be a mail sender or may be a mail recipient. By way of example and not limitation, an identity identifier may be a character string that is defined according to a predetermined rule, for example, an email box account, or a name that is self-defined by a user.

In implementations, an approach of obtaining the first identity identifier and the second identity identifier according to the electronic mail sent by the mail sender may include reading the first identity identifier and the second identity identifier from the electronic mail after the electronic mail is received. In implementations, the first identity identifier and the second identity identifier may be email box addresses of respective users. Alternatively, an approach of obtaining the first identity identifier and the second identity identifier may include obtaining an email box account of the mail sender and an email box account of the mail recipient after the electronic mail is received, and finding the first identity identifier bound to the email box account of the mail sender and the second identity identifier bound to the email box account of the mail recipient from a stored database according to the email box addresses.

The acquisition module 416 may obtain relationship data between the first identity identifier and the second identity identifier.

In implementations, relationship data may be used to represent a social relationship between users identified by identity identifiers. In implementations, relationship data may include a social relationship such as a hierarchical relationship in a company, a family relationship, a business relationship, or a friend relationship, etc. The hierarchical relationship may include superior, subordinate, peer, etc. The business relationship may include, for example, an ordinary customer, an important customer, a supplier, etc. The family relationship may include a father, a mother, an elder brother, a younger brother, a wife, a son, a daughter, etc. Apparently, the relationship data is not limited to the above examples, and one skilled in the art may also make other modifications under the insights of the technical essences of the present disclosure. Such modifications shall all fall within the scope of protection of the present disclosure, given that functions and effects that are the same as or similar to those of the present disclosure are achieved. In implementations, a form of representation of the relationship data may be a character string, which is used to represent a social relationship.

In implementations, a method of correspondingly storing the first identity identifier, the second identity identifier and the relationship data may be performed in terms of a data table. In the data table, a first column of data records identity identifiers from a first person, a second column of data records identity identifiers of target persons, and a third column of data is used to represent respective relationship data. A row of data in the data table may form a data object, and the data object includes an identity identifier from a first person, an identity identifier of a target person, and relationship data correspondingly. The relationship data may be used to represent a relationship between users that are identified by the identity identifier from the first person and the identity identifier of the target person. For example, a data object may include an identity identifier from a first person which is used to identify a user A, an identity identifier of a target person which is used to identify a user B, and relationship data being a superior. In this case, the user B can be considered as a superior of the user A. For another example, an identity identifier from a first person represents a user B, an identity identifier of a target person represents a user A, and relationship data is subordinate. In this case, the user A can be understood as a subordinate of the user B. Therefore, both the first identity identifier and the second identity identifier can be used as an identity identifier of a first person or an identity identifier of a target person. A difference is that respective relationship data may be different when the first identity identifier and the second identity identifier are individually used as an identity identifier a first person.

In implementations, a method of obtaining the relationship data by the acquisition module 416 may include searching for the relationship data that corresponds to the first identity identifier and the second identity identifier from locally stored relationship data, or may include downloading the relationship data from a predetermined server. In implementations, the second identity identifier that identifies the mail recipient may be searched from a data column that records identity identifiers of first persons during search to find the relationship data having the mail recipient as the first person.

The prompting command sending module 418 may send a prompting command to an instant communication server based on the relationship data in accordance with a predetermined rule, the prompting command including the second identity identifier.

In implementations, the instant communication server may provide a platform for instant communications between client terminals. Specifically, when different client terminals exchange instant communication information, information may be sent to the instant communication server first. In response to receiving the instant communication information, the instant communication server sends the information to a target client terminal. Specifically, the instant communication server may be a telecommunication device having computation, storage and network communication functions, or may be software that runs in the telecommunication device.

In implementations, the predetermined rule may include a rule that is set in advance, and the prompting command is sent when the relationship data satisfies logical settings of the rule. For example, the predetermined rule may include sending the prompting command when the mail sender is a superior or a senior family member of the mail recipient. Additionally, levels may be set up for roles represented by each piece of relationship data may be ranked. For example, in a company, a senior leader has a level of 3, an immediate superior has a level of 2, and a peer has a level of 1. For another example, father and mother have a level of 3, wife and son have a level of 2, and other relatives have a level of 1 or 0. The predetermined rule may further include sending the prompting command when the mail sender has a level higher than 2.

In implementations, sending the prompting command to the instant communication server by the prompting command sending module 418 may represent that the instant communication server is needed to send prompting information to a client terminal to inform a user identified by the second identity identifier that a mail is to be read. The instant communication server may send the prompting information to an instant communication client terminal used by the user that is identified by the second identity identifier according to the second identity identifier. Specifically, the prompting command may be a character string that is configured according to the predetermined rule. The second identity identifier included in the prompting command may be included as a portion of content of the prompting command, or may be included as an attachment to the prompting command.

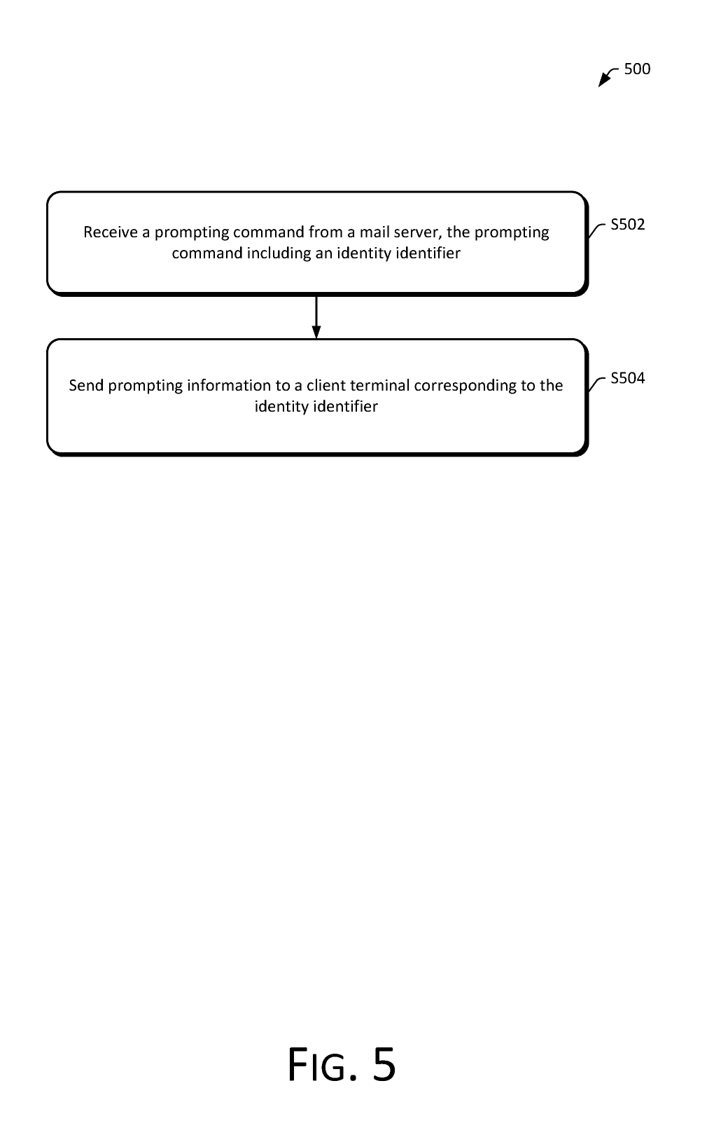

Referring to FIG. 5, the embodiments of the present disclosure further provide an electronic mail prompting method 500. The method 500 may include the following method blocks.

S502 receives a prompting command from a mail server, the prompting command including an identity identifier.

In implementations, the mail server may provide a platform for communicating electronic mails between email boxes. A receipt of a prompting command may indicate that an electronic mail received by the mail server is relatively important with respect to a user that is identified by the identity identifier or satisfies a preset rule, and prompting information needs to be sent to a client terminal of the user that is identified by the identity identifier to remind the user that a mail needs to be read and processed.

In implementations, the prompting command may be a character string that is set on the basis of a predetermined arrangement rule. The identity identifier included in the prompting command may be included as a portion of content of the prompting command, or the identity identifier may be included as an attachment to the prompting command.

S504 sends prompting information to a client terminal corresponding to the identity identifier.

In implementations, the client terminal may include a portable smart device, such as a mobile phone, a tablet computer, or a smart wearable device. The smart wearable device may include a smart wristband, a smart watch, smart glasses, etc. Apparently, the client terminal is not limited to the above examples. Alternatively, the client terminal may be software that runs in the foregoing devices.

In implementations, the identity identifier may have a correspondence relationship with the client terminal. The identity identifier may be a login account of the client terminal. Alternatively, a binding relationship between the identity identifier and the login account of the client terminal may exist, so that the login account of the client terminal can be determined based on the identity identifier. In this way, the prompting information can be sent to the client terminal based on the identity identifier.

In implementations, the prompting information may be a text, an image, a voice or a video. The prompting information may be sent to the client terminal by means of pushing, or may be sent to the client terminal in a form of a short message. If the client terminal is a mobile phone or a tablet computer, a phone number of the client terminal may be obtained, and prompting information in an audio form is played by dialing the phone number.

According to the embodiments of the present disclosure, prompting information can be sent to a client terminal of a user according to a prompting command that is received to remind a user that a mail needs to be read and processed. Since the client terminal is highly portable and the user is able to carry the client terminal therewith often, sending the prompting information to the client terminal can effectively inform the user that a mail needs to be read, thereby improving the timeliness in reading mails.

In implementations, the prompting command may further include prompting mode information, and the method block S504 may further include sending the prompting information to the client terminal in a prompting mode represented by the prompting mode information.

In implementations, the prompting command sent by the instant communication server may further include prompting mode information. The prompting mode information is used to represent a mode for sending prompting information to the client terminal. In implementations, modes for sending prompting information may include using a short message service of a mobile phone, using an instant communication message, using an information pushing, dialing a phone to establish a communication, establishing an online video, etc.

In implementations, the prompting mode information may be a character string that is set in advance. The prompting mode information included in the prompting command may be included as a portion of content of the prompting command, or the prompting mode information may be included as an attachment to the prompting command.

In implementations, the prompting command may further include information content. In the method block of sending prompting information, the information content may be acted as content of the prompting information.

In implementations, the prompting command sent by the instant communication server may further include information content. After receiving the prompting command, the instant communication server obtains the information content, and sends the information content as prompting information to the client terminal. In this way, the instant communication server does not need to further generate content of the prompting information, thereby alleviating the workload of the instant communication server.

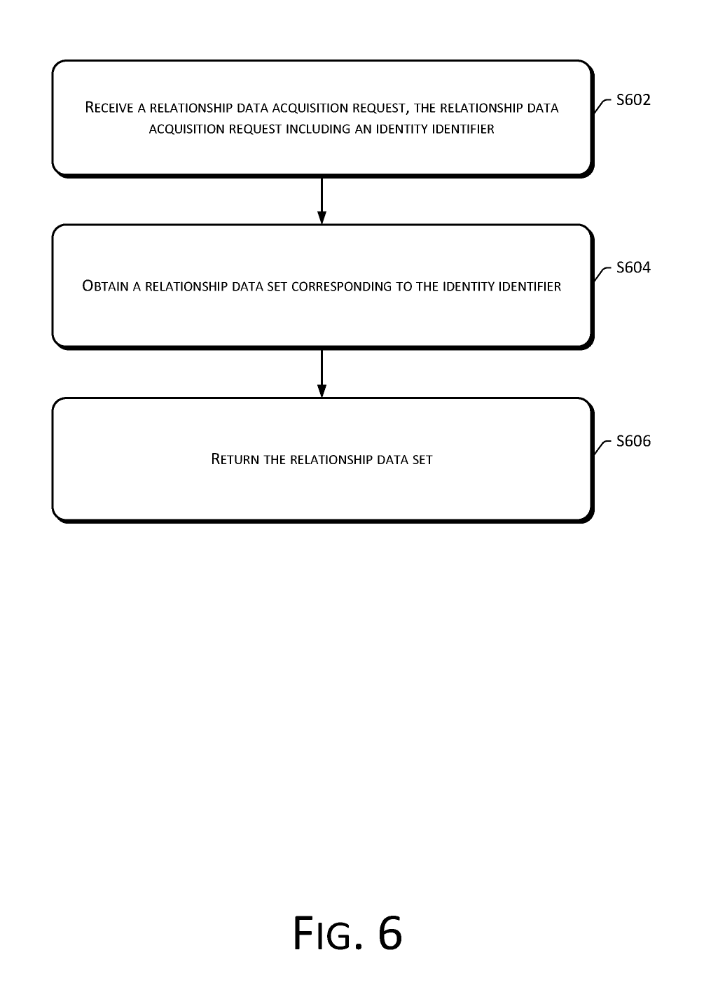

Referring to FIG. 6, in implementations, the electronic mail prompting method 500 may further include the following method blocks.

S602 receives a relationship data acquisition request, the relationship data acquisition request including an identity identifier.

S604 obtains a relationship data set corresponding to the identity identifier.

S606 returns the relationship data set.

In implementations, the instant communication server stores relationship data. A receipt of a relationship data acquisition request indicates that relationship data needs to be fed back. The identity identifier included in the relationship data acquisition request represents obtaining relationship data from a user identified by the identity identifier with the user acting as a first person. A method of including the identity identifier in the relationship data acquisition request may include the identity identifier being included as a portion of content of the relationship data acquisition request, or the identity identifier being included as an attachment to the relationship data acquisition request.

In implementations, relationship data and corresponding identity identifier(s) may be stored in a form of a data table. In a data table, a first column of data records identity identifiers of first persons, a second column of data records identity identifiers of target persons, and a third column of data is used to record relationship data. A row of data in the data table may form a data object, and the data object includes an identity identifier of a first person, an identity identifier of a target person, and relationship data correspondingly. The relationship data may be used to represent a relationship between users that are represented by the identity identifier of the first person and the identity identifier of the target person. For example, a data object may include an identity identifier of a first person which is used to identify a user A, an identity identifier of a target person which is used to identify a user B, and relationship data being superior. In this case, it may be understood that the user B is a superior of the user A. For another example, an identity identifier of a first person represents the user B, an identity identifier of a target person represents the user A, and relationship data is subordinate. In this case, it can be understood that the user A is a subordinate of the user B.

In implementations, during the process of obtaining a relationship data set, the identity identifiers of the first persons in the data table are searched for an identity identifier that is the same as the identity identifier included in the relationship data acquisition request to obtain at least one corresponding data object, with these data objects forming a relationship data set. The relationship data set is returned to a communication device that sends the relationship data acquisition request.

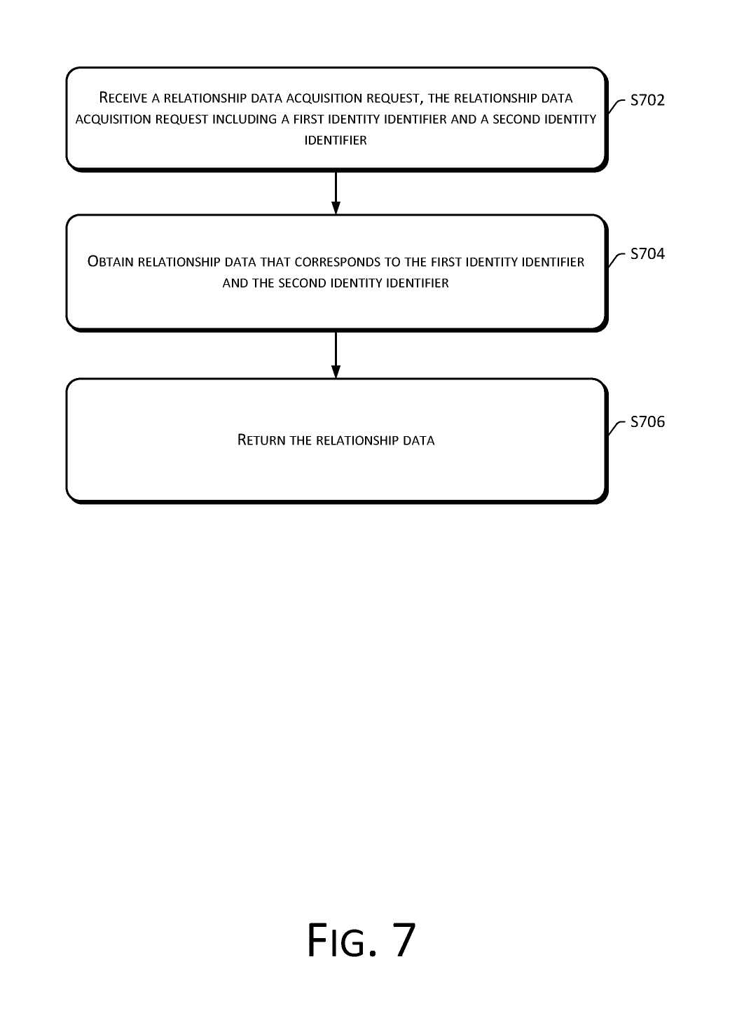

Referring to FIG. 7, in implementations, the electronic mail prompting method 500 may further include the following method blocks.

S702 receives a relationship data acquisition request, the relationship data acquisition request including a first identity identifier and a second identity identifier.

S704 obtains relationship data that corresponds to the first identity identifier and the second identity identifier.

S706 returns the relationship data.

In implementations, the instant communication server stores relationship data. A receipt of a relationship data acquisition request indicates that relationship data needs to be fed back. The second identity identifier included in the relationship data acquisition request represents obtaining relationship data having a user identified by the second identity identifier as a first person and a user identified by the first identity identifier as a target person. A method of including the first identity identifier and the second identity identifier in the relationship data acquisition request may include the first identity identifier and the second identity identifier being included as a portion of content of the relationship data acquisition request, or the first identity identifier and the second identity identifier being included as an attachment to the relationship data acquisition request.

In implementations, relationship data and corresponding identity identifier(s) may be stored in a form of a data table. In a data table, a first column of data records identity identifiers of first persons, a second column of data records identity identifiers of target persons, and a third column of data is used to record relationship data. A row of data in the data table may form a data object, and the data object includes an identity identifier of a first person, an identity identifier of a target person, and relationship data correspondingly. The relationship data may be used to represent a relationship between users that are represented by the identity identifier of the first person and the identity identifier of the target person. For example, a data object may include an identity identifier of a first person which is used to identify a user A, an identity identifier of a target person which is used to identify a user B, and relationship data being superior. In this case, it may be understood that the user B is a superior of the user A. For another example, an identity identifier of a first person represents the user B, an identity identifier of a target person represents the user A, and relationship data is subordinate. In this case, it can be understood that the user A is a subordinate of the user B.

In implementations, during a process of obtaining relationship data, the identity identifiers of the first persons in the data table are searched for the second identity identifier, and the identity identifiers of the target persons are searched for the first identity identifier. In response to finding a data object in which an identity identifier of a first person is the same as the second identity identifier and an identity identifier of a target person is the same as the first identity identifier, relationship data in the data object is read, and the relationship data is fed back to a communication device that sends the relationship data acquisition request.

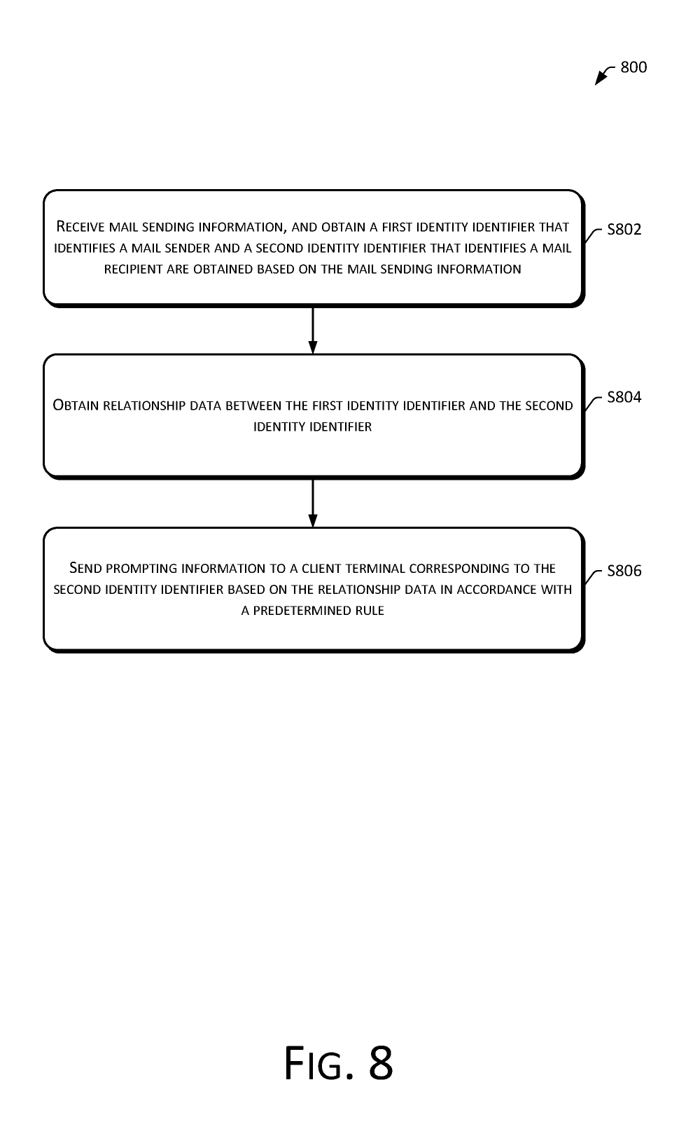

Referring to FIG. 8, the embodiments of the present disclosure further provide an electronic mail prompting method 800, which may include the following method blocks.

S802 receives mail sending information, and obtains a first identity identifier that identifies a mail sender and a second identity identifier that identifies a mail recipient based on the mail sending information.

In implementations, the mail sending information may be sent by a mail server after receiving an electronic mail. Alternatively, the mail sending information may be sent by a client terminal that sends an electronic mail when sending the electronic mail.

In implementations, the mail sending information is used to represent that a user has sent an electronic mail. In implementations, the mail sending information may be a character string that is set in advance. The mail sending information may include a first identity identifier and a second identity identifier, so that the first identity identifier and the second identity identifier can be obtained once the mail sending information is received. In implementations, a method of including the first identity identifier and the second identity identifier in the mail sending information may include having these two identifiers included as a portion of content of the mail sending information, or having these two identifiers included as an attachment to the mail sending information. The mail sending information may further include other data information that is able to represent identities of the mail sender and the mail recipient. After the data information is received, searching for identity identifiers corresponding to users represented by the data information can be performed locally, thus obtaining the first identity identifier and the second identity identifier.

In implementations, an identity identifier can be used to uniquely identify a user, and the user may be a mail sender or may be a mail recipient. In implementations, an identity identifier may be a character string that is defined according to a predetermined rule, for example, an email box account, or a name self-defined by the user.

S804 obtains relationship data between the first identity identifier and the second identity identifier.

In implementations, relationship data may be used to represent a social relationship between users identified by identity identifiers. In implementations, relationship data may include a social relationship such as a hierarchical relationship in a company, a family relationship, a business relationship, or a friend relationship, etc. The hierarchical relationship may include superior, subordinate, peer, etc. The business relationship may include, for example, an ordinary customer, an important customer, a supplier, etc. The family relationship may include a father, a mother, an elder brother, a younger brother, a wife, a son, a daughter, etc. Apparently, the relationship data is not limited to the above examples, and one skilled in the art may also make other modifications under the insights of the technical essences of the present disclosure. Such modifications shall all fall within the scope of protection of the present disclosure, given that functions and effects that are the same as or similar to those of the present disclosure are achieved. In implementations, a form of representation of the relationship data may be a character string, which is used to represent a social relationship.

In implementations, a method of correspondingly storing the first identity identifier, the second identity identifier and the relationship data may be performed in terms of a data table. In the data table, a first column of data records identity identifiers from a first person, a second column of data records identity identifiers of target persons, and a third column of data is used to represent respective relationship data. A row of data in the data table may form a data object, and the data object includes an identity identifier from a first person, an identity identifier of a target person, and relationship data correspondingly. The relationship data may be used to represent a relationship between users that are identified by the identity identifier from the first person and the identity identifier of the target person. For example, a data object may include an identity identifier from a first person which is used to identify a user A, an identity identifier of a target person which is used to identify a user B, and relationship data being a superior. In this case, the user B can be considered as a superior of the user A. For another example, an identity identifier from a first person represents a user B, an identity identifier of a target person represents a user A, and relationship data is subordinate. In this case, the user A can be understood as a subordinate of the user B. Therefore, both the first identity identifier and the second identity identifier can be used as an identity identifier of a first person or an identity identifier of a target person. A difference is that respective relationship data may be different when the first identity identifier and the second identity identifier are individually used as an identity identifier a first person.

In implementations, a method of obtaining the relationship data may include searching for the relationship data that corresponds to the first identity identifier and the second identity identifier from locally stored relationship data, or may include downloading the relationship data from a predetermined server. In implementations, the second identity identifier that identifies the mail recipient may be searched from a data column that records identity identifiers of first persons during search to find the relationship data having the mail recipient as the first person.

S806 sends prompting information to a client terminal corresponding to the second identity identifier based on the relationship data in accordance with a predetermined rule.

In implementations, the client terminal may include a portable smart device, such as a mobile phone, a tablet computer, or a smart wearable device. The smart wearable device may include a smart wristband, a smart watch, smart glasses and the like. Apparently, the client terminal is not limited to the above examples. Alternatively, the client terminal may be software that runs in the aforementioned devices.

In implementations, the instant communication server may provide a platform for instant communications between client terminals. Specifically, when different client terminals exchange instant communication information, information may be sent to the instant communication server first. In response to receiving the instant communication information, the instant communication server sends the information to a target client terminal. In implementations, the instant communication server may be a telecommunication device having computation, storage and network communication functions, or may be software that runs in the telecommunication device.

In implementations, when client terminals interact with the instant communication server, different client terminals can be distinguished from one another according to user accounts of the client terminals. A second identity identifier may be bound to a user account of a client terminal to achieve a correspondence relationship between the second identity identifier and the client terminal. Therefore, a user account bound to the second identity identifier can be found based on the second identity identifier, so that a corresponding client terminal can be determined.

In implementations, the predetermined rule may include a rule that is set in advance, and the prompting information is sent when the relationship data satisfies logical settings of the rule. For example, the predetermined rule may include sending the prompting information when the mail sender is a superior or a senior family member of the mail recipient. Additionally, levels may be set up for roles represented by each piece of relationship data may be ranked. For example, in a company, a senior leader has a level of 3, an immediate superior has a level of 2, and a peer has a level of 1. For another example, father and mother have a level of 3, wife and son have a level of 2, and other relatives have a level of 1 or 0. The predetermined rule may further include sending the prompting information when the mail sender has a level higher than 2.

In implementations, the prompting information may be a text, an image, a voice or a video. The prompting information may be sent to the client terminal by means of pushing, or may be sent to the client terminal in a form of a short message. If the client terminal is a mobile phone or a tablet computer, a phone number of the client terminal may be obtained, and prompting information in an audio form is played by dialing the phone number.

According to the embodiments of the present disclosure, prompting information can be sent to a client terminal of a user to inform a user that a mail needs to be read and processed. Since the client terminal is highly portable and the user is able to carry the client terminal therewith often, sending the prompting information to the client terminal can effectively inform the user that a mail needs to be read, thereby improving the timeliness in reading mails.

In implementations, the predetermined rule at S806 may include generating the prompting information when the relationship data is predetermined relationship data.

In implementations, a plurality of pieces of predetermined relationship data may be set in advance, and the prompting information is sent only when obtained relationship data is the predetermined relationship data. The predetermined relationship data may be specific relationship data that is designated. Specifically, for example, the predetermined relationship data may include senior leader, immediate superior and the like.

In implementations, the relationship data may be used to represent a social relationship or a family relationship, and the predetermined relationship data may represent a superior leader or a senior family member. Therefore, it may be treated that a mail sent from a superior leader or a senior family member is relatively important, and a user needs to be reminded to read the mail in a timely manner. For example, superior leaders may include a senior leader and an immediate superior. Senior family members may include grandfather, grandmother, father, mother, uncle and the like.

In implementations, rankings may be assigned to relationship data according to respective social relationships or family relationship represented by the relationship data, and the predetermined rule may include sending the prompting information when obtained relationship data having a rank higher than a predetermined rank.

In implementations, a role represented by the relationship data may be ranked. For example, in a company, a senior leader has a ranking of 3, an immediate superior has a ranking of 2, and a peer has a ranking of 1. For another example, father and mother have a ranking of 3, wife and son have a ranking of 2, and other relatives have a ranking of 1 or 0. The obtained relationship data also has a corresponding ranking. By setting a predetermined ranking in advance, relationship data for which prompting information needs to be sent and relationship data for which no prompting information needs to be sent can be distinguished. In addition, when a user configures whether prompting information needs to be sent, a modification process can be completed simply by modifying a ranking of a piece of relationship data or modifying a predetermined ranking, thus facilitating the user to perform configuration.

In implementations, the relationship data is used to represent an importance level, and the predetermined rule may include sending the prompting information when the relationship data having an important level larger than or equal to a predetermined importance level.

In implementations, the relationship data is used to represent an importance level. The importance level can be used to represent a relationship between the user corresponding to the first identity identifier and the user corresponding to the second identity identifier. Similarly, the importance level corresponds to the mail recipient as a first person. The higher the importance level is, the more important the mail sender is to the mail recipient, and therefore the mail recipient needs to process the mail in time. For example, a user A, a user B and a user C exist, where the user C is an ordinary employee, the user A is a senior leader, and the user B is an immediate superior of the user C. With the user C as the first person, the user A may have an importance level of 3, the user B may have an importance level of 2, and the predetermined importance level may be 2. In this case, when the user A or the user B sends a mail to the user C, prompting information will be sent to the instant communication server, to cause the instant communication server to notify a client terminal of the user C that an electronic mail is to be read. With the user B as a first person, the user A may have an importance level of 3, the user C may have an importance level of 1, and the predetermined importance level may be 2. In this case, when the user A sends an electronic mail to the user B, a client terminal of the user B will receive prompting information. On the other hand, when the user C sends an electronic mail to the user B, the client terminal of the user B will not receive prompting information.

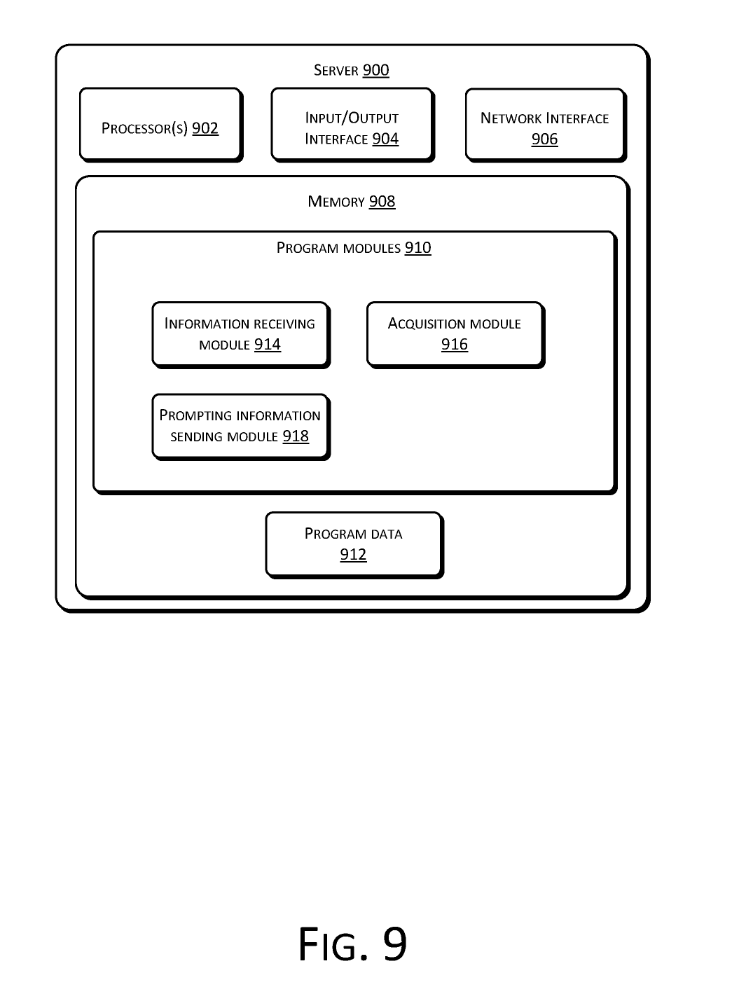

Referring to FIG. 9, the embodiments of the present disclosure further provide a server 900. In implementations, the server 900 may include one or more computing devices. By way of example and not limitation, the server 900 may include one or more processors 902, an input/output (I/O) interface 904, a network interface 906 and memory 908. The memory 908 may include a form of computer-readable media as described in the foregoing description.

In implementations, the memory 908 may include program modules 910 and program data 912. The program modules 910 may include an information receiving module 914, an acquisition module 916, and a prompting information sending module 918.

The information receiving module 914 may receive mail sending information, and obtain a first identity identifier that identifies a mail sender and a second identity identifier that identifies a mail recipient based on the mail sending information.

In implementations, the mail sending information may be sent by a mail server after receiving an electronic mail. Alternatively, the mail sending information may be sent by a client terminal that sends an electronic mail when sending the electronic mail.

In implementations, the mail sending information is used to represent that a user has sent an electronic mail. In implementations, the mail sending information may be a character string that is set in advance. The mail sending information may include a first identity identifier and a second identity identifier, so that the first identity identifier and the second identity identifier can be obtained once the mail sending information is received. In implementations, a method of including the first identity identifier and the second identity identifier in the mail sending information may include having these two identifiers included as a portion of content of the mail sending information, or having these two identifiers included as an attachment to the mail sending information. The mail sending information may further include other data information that is able to represent identities of the mail sender and the mail recipient. After the data information is received, searching for identity identifiers corresponding to users represented by the data information can be performed locally, thus obtaining the first identity identifier and the second identity identifier.

In implementations, an identity identifier can be used to uniquely identify a user, and the user may be a mail sender or a mail recipient. In implementations, the identity identifier may be a character string that is defined according to a predetermined rule, for example, an email box account, or a name self-defined by the user.

The acquisition module 916 may obtain relationship data between the first identity identifier and the second identity identifier.

In implementations, relationship data may be used to represent a social relationship between users identified by identity identifiers. In implementations, relationship data may include a social relationship such as a hierarchical relationship in a company, a family relationship, a business relationship, or a friend relationship, etc. The hierarchical relationship may include superior, subordinate, peer, etc. The business relationship may include, for example, an ordinary customer, an important customer, a supplier, etc. The family relationship may include a father, a mother, an elder brother, a younger brother, a wife, a son, a daughter, etc. Apparently, the relationship data is not limited to the above examples, and one skilled in the art may also make other modifications under the insights of the technical essences of the present disclosure. Such modifications shall all fall within the scope of protection of the present disclosure, given that functions and effects that are the same as or similar to those of the present disclosure are achieved. In implementations, a form of representation of the relationship data may be a character string, which is used to represent a social relationship.

In implementations, a method of correspondingly storing the first identity identifier, the second identity identifier and the relationship data may be performed in terms of a data table. In the data table, a first column of data records identity identifiers from a first person, a second column of data records identity identifiers of target persons, and a third column of data is used to represent respective relationship data. A row of data in the data table may form a data object, and the data object includes an identity identifier from a first person, an identity identifier of a target person, and relationship data correspondingly. The relationship data may be used to represent a relationship between users that are identified by the identity identifier from the first person and the identity identifier of the target person. For example, a data object may include an identity identifier from a first person which is used to identify a user A, an identity identifier of a target person which is used to identify a user B, and relationship data being a superior. In this case, the user B can be considered as a superior of the user A. For another example, an identity identifier from a first person represents a user B, an identity identifier of a target person represents a user A, and relationship data is subordinate. In this case, the user A can be understood as a subordinate of the user B. Therefore, both the first identity identifier and the second identity identifier can be used as an identity identifier of a first person or an identity identifier of a target person. A difference is that respective relationship data may be different when the first identity identifier and the second identity identifier are individually used as an identity identifier a first person.

In implementations, a method of obtaining the relationship data may include searching for the relationship data that corresponds to the first identity identifier and the second identity identifier from locally stored relationship data, or may include downloading the relationship data from a predetermined server. In implementations, the second identity identifier that identifies the mail recipient may be searched from a data column that records identity identifiers of first persons during search to find the relationship data having the mail recipient as the first person.

The prompting information sending module 918 may send prompting information to a client terminal corresponding to the second identity identifier based on the relationship data in accordance with a predetermined rule.

In implementations, the client terminal may include a portable smart device, such as a mobile phone, a tablet computer, or a smart wearable device. The smart wearable device may include a smart wristband, a smart watch, smart glasses and the like. Apparently, the client terminal is not limited to the above examples. Alternatively, the client terminal may be software that runs in the aforementioned devices.

In implementations, the instant communication server may provide a platform for instant communications between client terminals. Specifically, when different client terminals exchange instant communication information, information may be sent to the instant communication server first. In response to receiving the instant communication information, the instant communication server sends the information to a target client terminal. In implementations, the instant communication server may be a telecommunication device having computation, storage and network communication functions, or may be software that runs in the telecommunication device.

In implementations, when client terminals interact with the instant communication server, different client terminals can be distinguished from one another according to user accounts of the client terminals. A second identity identifier may be bound to a user account of a client terminal to achieve a correspondence relationship between the second identity identifier and the client terminal. Therefore, a user account bound to the second identity identifier can be found based on the second identity identifier, so that a corresponding client terminal can be determined.

In implementations, the predetermined rule may include a rule that is set in advance, and the prompting information is sent when the relationship data satisfies logical settings of the rule. For example, the predetermined rule may include sending the prompting information when the mail sender is a superior or a senior family member of the mail recipient. Additionally, levels may be set up for roles represented by each piece of relationship data may be ranked. For example, in a company, a senior leader has a level of 3, an immediate superior has a level of 2, and a peer has a level of 1. For another example, father and mother have a level of 3, wife and son have a level of 2, and other relatives have a level of 1 or 0. The predetermined rule may further include sending the prompting information when the mail sender has a level higher than 2.

In implementations, the prompting information may be a text, an image, a voice or a video. The prompting information may be sent to the client terminal by means of pushing, or may be sent to the client terminal in a form of a short message. If the client terminal is a mobile phone or a tablet computer, a phone number of the client terminal may be obtained, and prompting information in an audio form is played by dialing the phone number.

According to the embodiments of the present disclosure, prompting information can be sent to a client terminal of a user to inform a user that a mail needs to be read and processed. Since the client terminal is highly portable and the user is able to carry the client terminal therewith often, sending the prompting information to the client terminal can effectively inform the user that a mail needs to be read, thereby improving the timeliness in reading mails.

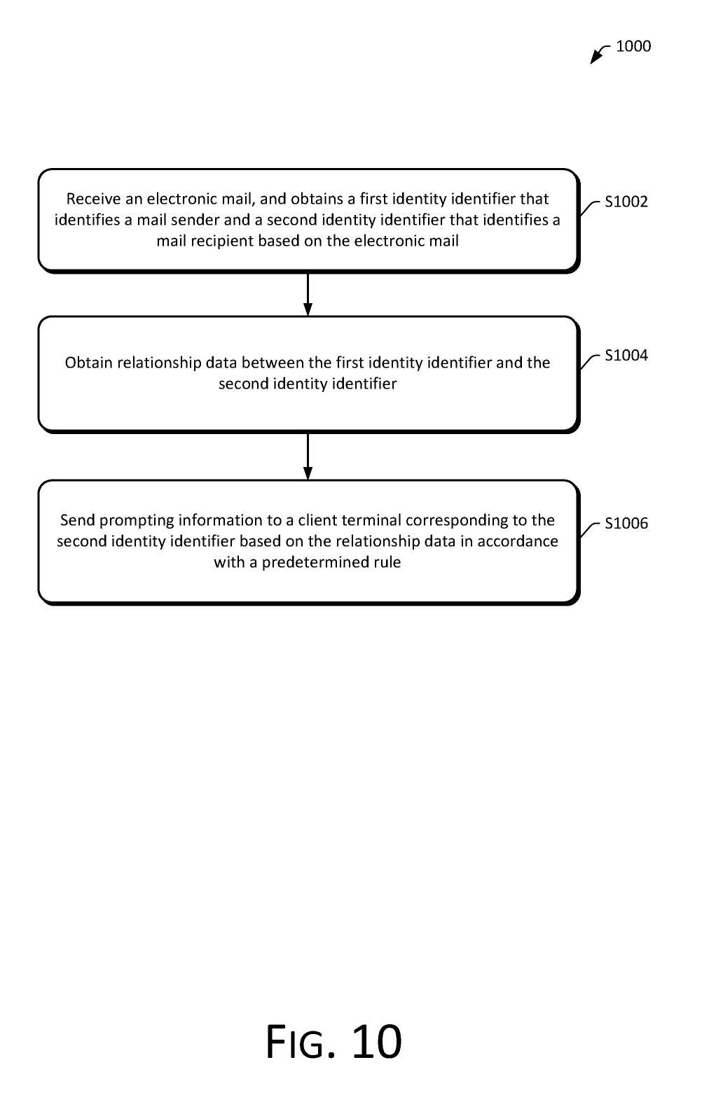

Referring to FIG. 10, the embodiments of the present disclosure further provide an electronic mail prompting method 1000, which may include the following method blocks.

S1002 receives an electronic mail, and obtains a first identity identifier that identifies a mail sender and a second identity identifier that identifies a mail recipient based on the electronic mail.

In implementations, a mail sender may be a user that sends an electronic mail. A mail recipient may be a user that receives an electronic mail. An identity identifier can be used to uniquely identify a user, and the user may be a mail sender or a mail recipient. In implementations, the identity identifier may be a character string that is defined according to a predetermined rule, for example, an email box account, or a name self-defined by the user.

In implementations, an approach of obtaining the first identity identifier and the second identity identifier based on the electronic mail sent by the mail sender may include reading the first identity identifier and the second identity identifier from the electronic mail after the electronic mail is received. In implementations, the first identity identifier and the second identity identifier may be email box addresses of respective users. Alternatively, an approach of obtaining the first identity identifier and the second identity identifier may include obtaining an email box account of the mail sender and an email box account of the mail recipient after the electronic mail is received, and finding the first identity identifier bound to the email box account of the mail sender and the second identity identifier bound to the email box account of the mail recipient from a stored database according to the email box addresses.

S1004 obtains relationship data between the first identity identifier and the second identity identifier.

In implementations, relationship data may be used to represent a social relationship between users identified by identity identifiers. In implementations, relationship data may include a social relationship such as a hierarchical relationship in a company, a family relationship, a business relationship, or a friend relationship, etc. The hierarchical relationship may include superior, subordinate, peer, etc. The business relationship may include, for example, an ordinary customer, an important customer, a supplier, etc. The family relationship may include a father, a mother, an elder brother, a younger brother, a wife, a son, a daughter, etc. Apparently, the relationship data is not limited to the above examples, and one skilled in the art may also make other modifications under the insights of the technical essences of the present disclosure. Such modifications shall all fall within the scope of protection of the present disclosure, given that functions and effects that are the same as or similar to those of the present disclosure are achieved. In implementations, a form of representation of the relationship data may be a character string, which is used to represent a social relationship.

In implementations, a method of correspondingly storing the first identity identifier, the second identity identifier and the relationship data may be performed in terms of a data table. In the data table, a first column of data records identity identifiers from a first person, a second column of data records identity identifiers of target persons, and a third column of data is used to represent respective relationship data. A row of data in the data table may form a data object, and the data object includes an identity identifier from a first person, an identity identifier of a target person, and relationship data correspondingly. The relationship data may be used to represent a relationship between users that are identified by the identity identifier from the first person and the identity identifier of the target person. For example, a data object may include an identity identifier from a first person which is used to identify a user A, an identity identifier of a target person which is used to identify a user B, and relationship data being a superior. In this case, the user B can be considered as a superior of the user A. For another example, an identity identifier from a first person represents a user B, an identity identifier of a target person represents a user A, and relationship data is subordinate. In this case, the user A can be understood as a subordinate of the user B. Therefore, both the first identity identifier and the second identity identifier can be used as an identity identifier of a first person or an identity identifier of a target person. A difference is that respective relationship data may be different when the first identity identifier and the second identity identifier are individually used as an identity identifier a first person.

In implementations, a method of obtaining the relationship data may include searching for the relationship data that corresponds to the first identity identifier and the second identity identifier from locally stored relationship data, or may include downloading the relationship data from a predetermined server. In implementations, the second identity identifier that identifies the mail recipient may be searched from a data column that records identity identifiers of first persons during search to find the relationship data having the mail recipient as the first person.

S1006 sends prompting information to a client terminal corresponding to the second identity identifier based on the relationship data in accordance with a predetermined rule.

In implementations, the client terminal may include a portable smart device, such as a mobile phone, a tablet computer, or a smart wearable device. The smart wearable device may include a smart wristband, a smart watch, smart glasses, etc. Apparently, the client terminal is not limited to the above examples. Alternatively, the client terminal may include software that runs in the aforementioned devices.

In implementations, a server may provide a platform for instant communications between client terminals. Specifically, when different client terminals exchange instant communication information, information may be sent to the server first. In response to receiving the instant communication information, the server sends the information to a target client terminal. Specifically, the server may be a telecommunication device having computation, storage and network communication functions, or may be software that runs in the telecommunication device.

In implementations, when client terminals interact with the server, different client terminals can be distinguished from one another according to user accounts of the client terminals. A second identity identifier may be bound to a user account of a client terminal to form a correspondence relationship between the second identity identifier and the client terminal. Therefore, a user account bound to a second identity identifier can be found based on the second identity identifier, so that a corresponding client terminal can be determined.

In implementations, the predetermined rule may include a rule that is set in advance, and the prompting information is sent when the relationship data satisfies logical settings of the rule. For example, the predetermined rule may include sending the prompting information when the mail sender is a superior or a senior family member of the mail recipient. Additionally, levels may be set up for roles represented by each piece of relationship data may be ranked. For example, in a company, a senior leader has a level of 3, an immediate superior has a level of 2, and a peer has a level of 1. For another example, father and mother have a level of 3, wife and son have a level of 2, and other relatives have a level of 1 or 0. The predetermined rule may further include sending the prompting information when the mail sender has a level higher than 2.

In implementations, the prompting information may be a text, an image, a voice or a video. The prompting information may be sent to the client terminal by means of pushing, or may be sent to the client terminal in a form of a short message. If the client terminal is a mobile phone or a tablet computer, a phone number of the client terminal may be obtained, and prompting information in an audio form is played by dialing the phone number.

According to the embodiments of the present disclosure, prompting information can be sent to a client terminal of a user to inform a user that a mail needs to be read and processed. Since the client terminal is highly portable and the user is able to carry the client terminal therewith often, sending the prompting information to the client terminal can effectively inform the user that a mail needs to be read, thereby improving the timeliness in reading mails.

As can be seen from the above technical solutions provided in the embodiments of the present disclosure, by combining an electronic mail system with an instant communication technology, and further using a social relationship between a mail sender and a mail recipient (i.e., representing the social relationship via relationship data), the present disclosure is able to distinguish an importance level of a current mail with respect to the mail recipient based on the social relationship between the mail sender and the mail recipient. In this way, sending prompting information to an instant communication client terminal of a user based on relationship data can be achieved, thus enabling the user to learn that a new mail is to be read as soon as possible, and thereby effectively improving the timeliness of a response of the user with respect to the mail, especially the timeliness of responding to relatively important mails by the user.

Multiple embodiments of the present disclosure have been described in the present disclosure. One skilled in the art should understand that the embodiments of the present disclosure can be combined with one another. In addition, one skilled in the art should know that various modifications and variations can be made to the present disclosure without departing from the spirit of the present disclosure, and it is intended that the appended claims cover these modifications and variations without departing from the spirit of the present disclosure.

What is claimed is:

1. A method implemented by one or more computing devices, the method comprising:
receiving an electronic mail;
obtaining a first identity identifier that identifies a mail sender and a second identity identifier that identifies a mail recipient based at least in part on the electronic mail;
obtaining relationship data between the first identity identifier and the second identity identifier; and
sending a prompting command to an instant communication server based on the relationship data and in accordance with a predetermined rule, the prompting command including the second identity identifier.

2. The method of claim 1, wherein obtaining the relationship data comprises:
sending a relationship data acquisition request to the instant communication server, the relationship data acquisition request including the second identity identifier;
receiving a relationship data set returned by the instant communication server, the relationship data set including at least one data object and the at least one data object including respective identity identifiers and respective relationship data corresponding thereto; and
searching the relationship data set for an identity identifier that is the same as the first identity identifier to obtain the relationship data between the first identity identifier and the second identity identifier.

3. The method of claim 1, wherein obtaining the relationship data comprises:
sending a relationship data acquisition request to the instant communication server, the relationship data acquisition request including the first identity identifier and the second identity identifier; and
receiving relationship data returned by the instant communication server.

4. The method of claim 1, wherein obtaining the relationship data comprises reading locally stored relationship data that corresponds to the first identity identifier and the second identity identifier.

5. The method of claim 1, wherein the predetermined rule comprises sending the prompting command in response to determining that the relationship data includes predetermined relationship data.

6. The method of claim 1, wherein the relationship data is used for representing a social relationship or a family relationship.

7. The method of claim 1, wherein relationship data is ranked according to a social relationship or family relationship represented by the relationship data, and the predetermined rule includes sending the prompting command in response to determining that the relationship data has a ranking higher than a predetermined ranking.

8. The method of claim 1, wherein the relationship data is used for representing an importance level, and the predetermined rule includes sending the prompting command in response to determining that the relationship data having an important level that is higher than or equal to a predetermined importance level.

9. One or more computer-readable media storing executable instructions that, when executed by one or more processors, cause the one or more processors to perform acts comprising:
receiving a prompting command from a mail server, the prompting command including an identity identifier; and
sending prompting information to a client terminal corresponding to the identity identifier.

10. The one or more computer-readable media of claim 9, wherein the prompting command further comprises prompting mode information, and sending the prompting information further comprises sending the prompting information to the client terminal in a prompting mode represented by the prompting mode information.

11. The one or more computer-readable media of claim 9, wherein the prompting command further comprises information content, and sending prompting information further comprises sending the information content as a portion of content of the prompting information.

12. The one or more computer-readable media of claim 9, wherein the acts further comprise:
receiving a relationship data acquisition request, the relationship data acquisition request carries another identity identifier;
obtaining a relationship data set corresponding to the other identity identifier; and
returning the relationship data set to a communication device from which the relationship data acquisition request is received.

13. The one or more computer-readable media of claim 9, wherein the acts further comprise:
receiving a relationship data acquisition request, the relationship data acquisition request including a first identity identifier and a second identity identifier;
obtaining relationship data that corresponds to the first identity identifier and the second identity identifier; and
returning the relationship data to a communication device from which the relationship data acquisition request is received.

14. An server comprising:
one or more processors;
memory storing executable instructions that, when executed by the one or more processors, cause the one or more processors to perform acts comprising:
receiving mail sending information;
obtaining a first identity identifier that identifies a mail sender and a second identity identifier that identifies a mail recipient based at least in part on the mail sending information;
obtaining relationship data between the first identity identifier and the second identity identifier; and
sending prompting information to a client terminal corresponding to the second identity identifier based on the relationship data and in accordance with a predetermined rule.

15. The server of claim 14, wherein the predetermined rule comprises sending the prompting information in response to determining that the relationship data includes predetermined relationship data.

16. The server of claim 14, wherein the relationship data is used to represent a social relationship or a family relationship.

17. The server of claim 14, wherein the acts further comprise ranking the relationship data according to a social relationship or family a relationship represented by the relationship data, and wherein the predetermined rule comprises sending the prompting information in response to the relationship data having a ranking that is higher than a predetermined ranking.

18. The server of claim 14, wherein the relationship data is used to represent an importance level, and the predetermined rule comprises sending the prompting information in response to determining that the relationship data having an important level that is larger than or equal to a predetermined importance level.

19. The server of claim 14, wherein obtaining the relationship data comprises:
sending a relationship data acquisition request to an instant communication server, the relationship data acquisition request including the second identity identifier;
receiving a relationship data set returned by the instant communication server, the relationship data set including at least one data object and the at least one data object including respective identity identifiers and respective relationship data corresponding thereto; and
searching the relationship data set for an identity identifier that is the same as the first identity identifier to obtain the relationship data between the first identity identifier and the second identity identifier.

20. The server of claim 14, wherein obtaining the relationship data comprises reading locally stored relationship data that corresponds to the first identity identifier and the second identity identifier.
